(19) United States
(12) Patent Application Publication
(10) Pub. No.: US 2014/0335429 A1
(43) Pub. Date: Nov. 13, 2014

(54) ALKALINE BATTERY WITH ELECTROLYTE GRADIENT

(71) Applicant: ZINC AIR FUEL CELLS, INC., Columbia Falls, MT (US)

(72) Inventors: Ronald D. Brost, Whitefish, MT (US); Kristine M. Brost, Whitefish, MT (US); Howard F. Wilkins, Kalispell, MT (US); Randolph M. Kosted, Kalispell, MT (US); Paula J. Kosted, Kalispell, MT (US); Adam Weisenstein, Whitefish, MT (US); William A. Garcia, Columbia Falls, MT (US); David Wilkins, Kalispell, MT (US)

(73) Assignee: Zinc Air Fuel Cells, Inc., Columbia Falls, MT (US)

(21) Appl. No.: 13/891,877

(22) Filed: May 10, 2013

(51) Int. Cl. H01M 12/02

(52) U.S. Cl. CPC H01M 12/02
USPC 429/405; 429/407

(57) ABSTRACT

A membrane electrode assembly includes a gas diffusion layer, a catalytic layer in fluid communication with the gas diffusion layer, an anodic layer and a bipolar solid electrolyte disposed between the catalytic and anodic layers. The bipolar solid electrolyte inhibits carbonate formation in air breathing alkaline cells and inhibits dendritic growth between the anodic and catalytic layers.

### TECHNICAL FIELD

This disclosure relates to alkaline batteries, for example, air breathing alkaline batteries and electrolyte arrangements therein.

### BACKGROUND

Certain batteries may have an alkaline, as opposed to acidic, electrolyte. Such batteries may have higher energy density but shorter operational life relative to other batteries.

### SUMMARY

An alkaline air breathing battery includes a gas diffusion layer, an air electrode in contact with the gas diffusion layer, a counter electrode, and a hydroxide containing layered electrolyte. The layered electrolyte is in ionic communication with and induces a hydroxide ion gradient between the air and counter electrodes such that a hydroxide ion concentration at an interface between the air electrode and layered electrolyte is less than a hydroxide ion concentration at an interface between the counter electrode and layered electrolyte. This reduces carbonate formation within the air electrode and maintains hydroxide reaction at the counter electrode.

An alkaline air breathing battery includes a membrane electrode assembly and a current collector in contact with the membrane electrode assembly. The membrane electrode assembly includes a catalyst layer, an anodic layer and a bipolar solid electrolyte disposed between the layers. The bipolar solid electrolyte inhibits reaction of carbon dioxide and hydroxide at a triple phase boundary of the catalyst layer and promotes oxidation of the anodic layer.

An alkaline air breathing battery includes a membrane electrode assembly and a current collector in contact with the membrane electrode assembly. The membrane electrode assembly includes a gas diffusion layer, a catalytic layer in fluid communication with the gas diffusion layer, an anodic layer and a bipolar solid electrolyte disposed between the catalytic and anodic layers. The membrane electrode assembly and current collector are configured such that the battery, when cycled, achieves at least 40 charge-discharge cycles at a depth of discharge of at least 80%.

An alkaline air breathing battery includes a membrane electrode assembly and a current collector in contact with the membrane electrode assembly. The membrane electrode assembly includes a gas diffusion layer, a catalytic layer in fluid communication with the gas diffusion layer, an anodic layer and a bipolar solid electrolyte disposed between the catalytic and anodic layers. The solid electrolyte inhibits, during charge, dendritic growth between the anodic and catalytic layers.

An alkaline battery includes a cathodic layer, an anodic layer, a bipolar solid electrolyte disposed between the cathodic and anodic layers, and a current collector in contact with at least one of the layers. The solid electrolyte inhibits, during charge, dendritic growth between the anodic and cathodic layers.

### BRIEF DESCRIPTION OF THE DRAWINGS

FIGS. 1 and 2 are schematic diagrams, in cross-section, of portions of alkaline air breathing batteries.

FIG. 3 is a schematic diagram, in cross-section, of an alkaline flow battery.

FIG. 4 is a discharge plot of cell potential versus time for an alkaline air breathing battery including a layered electrolyte.

FIG. 5 is a cycling plot of cell potential and current versus time for an alkaline air breathing battery.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

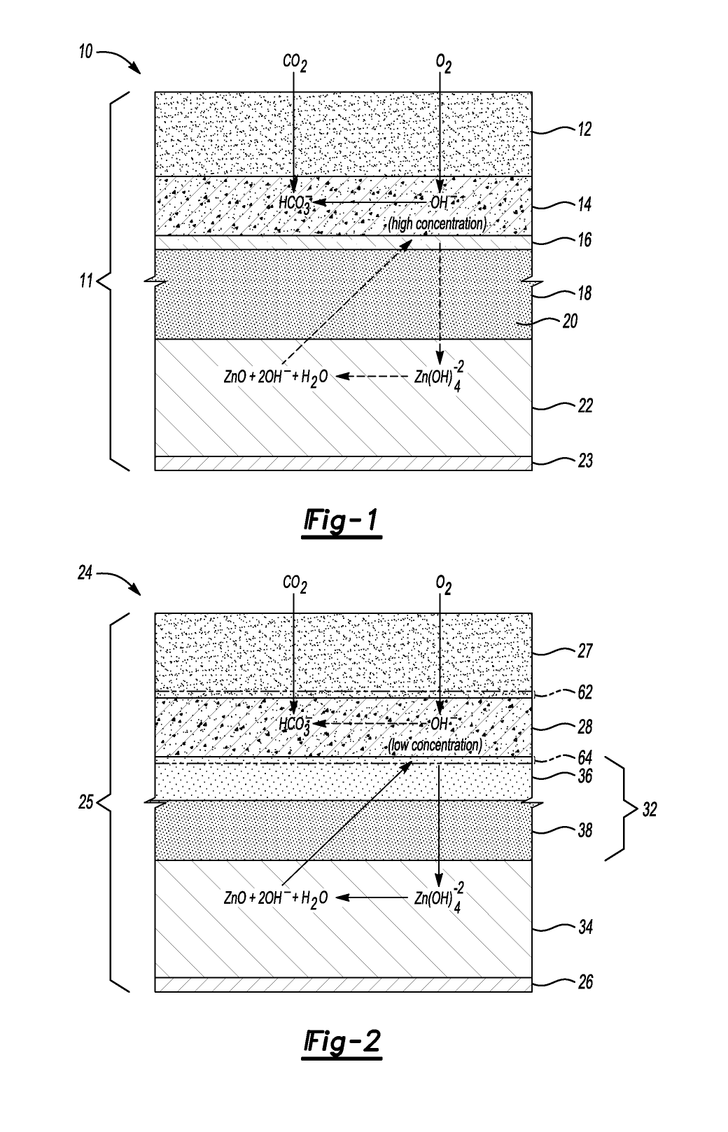

With reference to FIG. 1, an alkaline battery 10 includes an electrode arrangement 11. The electrode arrangement 11 includes a gas diffusion layer 12, a catalyst layer (including a current collector) 14 in contact with the gas diffusion layer 12, a separator 16 (e.g., fibrous paper, porous polyethylene), an electrolyte reservoir 18 (e.g., void space, fibrous paper or other absorbent material, gel) for an alkaline electrolyte 20 (e.g., aqueous potassium hydroxide) in ionic communication with the catalyst 14, a counter (or negative) electrode 22 (e.g., zinc/zinc oxide) in ionic communication with the electrolyte 20, and a current collector 23 in contact with the counter electrode 22. The separator 16, as the name suggests, is arranged to physically separate the catalyst 14 and counter electrode 22. The alkaline electrolyte 20, however, permeates the catalyst 14, separator 16 and counter electrode 22 and has, in this example, a generally uniform concentration of hydroxide ions.

Passivation of hydroxide by reaction with carbon dioxide can be a failure mode in air breathing alkaline electrochemical cells. The passivation reaction is promoted by high concentrations of hydroxide and occurs wherever carbon dioxide from the air flowing into the battery meets and mixes with high concentrations of hydroxide ion to form bicarbonate ion. Not only may the bicarbonate ion precipitate and clog the porous catalyst electrode 14, but the occurrence of this reaction also reduces the availability of the hydroxide through chemical depletion. The hydroxide passivation reaction thus irreversibly reduces the operating life of these systems due to either clogging of the electrodes, reduction of hydroxide electrolyte concentration, or both.

The mechanism for the preferred alkaline anodic corrosion involves a reaction between the oxidized zinc with available hydroxide to form zincate (zinc tetrahydroxide ion), which then decomposes to zinc oxide. This reaction is sensitive to hydroxide concentration. Therefore, simply lowering the hydroxide concentration in the electrolyte 20 such that the hydroxide concentration is insufficient to react with carbon dioxide is not a viable solution to this problem: a lower concentration of hydroxide reduces the rate of zinc oxide formation at the negative electrode 22, which leads to poor efficiency and low energy density.

Another possible method of reducing the rate of hydroxide passivation includes scrubbing (removing) the carbon dioxide from the incoming air. This method would use an air manifold system that directs airflow through first a scavenger material such as solid potassium hydroxide, which reacts with carbon dioxide and removes it from the airstream, and then directs the carbon dioxide-free air to react within the metal-air cell. Alternatively, a swing-absorber that uses a carbon-dioxide absorbing material such as pyrogallol may be used to absorb the carbon dioxide from the incoming air, and then desorb carbon dioxide into the outgoing air. Both of these methods, however, increase system weight, complexity, and cost of operation, especially when scavengers are used. In addition, many carbon dioxide absorbents and scavengers are also hygroscopic and thus substantially reduce the amount of humidity in the airstream, which may result in reduced cell performance or in the need for a re-hydration step, again increasing system weight, complexity, and cost of operation. Moreover, these added air handling methods would require forced convection with its attendant pumps, fans and piping.

Another possible solution to the carbonation problem may involve the use of a membrane that provides a carbon dioxide barrier, but still allows oxygen to pass. Conceptually a membrane that would prevent carbon dioxide from entering the cell, yet permit enough oxygen to diffuse into the cell would meet design requirements, but such a selective material is not presently known.

Separately, cell construction should prevent the transport of oxygen and carbon dioxide to the anode, where these gasses would react directly with either the metal anode or the hydroxide respectively.

The needs of oxygen permeation to the cathodic catalyst, low reactivity of the electrolyte with carbon dioxide, exclusion of air from the metal anode, and an alkaline environment for the anode may be met with an electrolyte structure that produces a hydroxide gradient in which the electrolyte that is in contact with the catalyst and air phase is not reactive with carbon dioxide (e.g. has poor availability of hydroxide or is acidic) and the electrolyte that is in contact with the anode is alkaline such that the anodic corrosion reaction is facilitated. In addition, the acidic electrolyte that is in contact with the catalyst may be configured to act as a gas barrier/ionically conductive phase that separates the catalyst layer, oxygen and carbon dioxide from the alkaline part of the electrolyte and anode. The alkaline electrolyte may include a polymeric anion-conductive material that is rich in hydroxide (higher pH or higher [OH⁻]), while the more acidic phase may include an acidic polymeric material that has a lower concentration of hydroxide (lower pH or lower [OH⁻]). Because the hydroxide distribution in such an arrangement may favor high concentrations at the anode and low concentrations at the cathode, the cathode may be protected from passivation resulting from carbonate formation while facilitating alkaline anodic corrosion of the metal anode. The gas barrier created by the ionomeric acidic layer may concurrently prevent direct oxidation of the metal by free or dissolved oxygen gas.

With reference to FIG. 2 for example, an alkaline air breathing battery 24 includes a membrane electrode assembly 25 and a current collector 26. In other examples, the membrane electrode assembly 25 may include the current collector 26, etc. The membrane electrode assembly 25 includes a gas diffusion layer 27, an air electrode (catalyst and current collector) 28 in contact with the gas diffusion layer 27, a bipolar solid electrolyte 32 in ionic communication with the air electrode 28, and a counter electrode 34 (e.g., an anodic metal) in ionic communication with the solid electrolyte 32.

The solid electrolyte 32 may include, for example, a neutral or acidic (e.g., pH less than 9) gas impermeable ionomer phase (layer) 36 and an alkaline continuous ionomer phase (layer) 38. The juxtaposition of the layers 36, 38 will induce a stable hydroxide gradient in which the hydroxide ion concentration associated with the neutral (or acidic) phase 36 is lower than that of the alkaline phase 38. The hydroxide ion concentration of the neutral (or acidic) phase 36, for example, may be less than 10⁻⁵ molar, while the hydroxide ion concentration of the alkaline ionomer phase 38, for example, may be greater than 4 molar. A concentration of 10⁻⁵ molar is considered sufficient to prevent dendritic growth therethrough, and so the gradient induced by this arrangement is capable of reducing or eliminating dendritic growth in metal anode batteries while maintaining the alkaline conditions at the anode that are required for efficient operation. Alternatively, a solid alkaline electrolyte may be treated on one side to increase the acidity associated therewith. Other configurations and concentrations may also be used depending on design considerations, expected operating environment, etc.

The acidic polymer 36 may be a material that, on a molecular scale, consists of strongly anionic sites on a structural polymeric backbone (e.g., an ionically conductive dielectric gas impermeable layer such as sulfonated tetrafluoroethylene based fluoropolymer-copolymer or Nafion®), while the alkaline polymer 38 may be a material that consists of strongly cationic sites on a polymeric backbone. When these two materials are in contact with one another, an equilibrium will be established that will distribute an anion (such as hydroxide) preferentially on the alkaline polymer 38, and will have a substantial reduction in hydroxide on the acidic polymer 36. This condition would make it improbable that sufficient hydroxide will be available to react with free carbon dioxide, and will thereby stabilize the battery with respect to carbon dioxide. This is anecdotally realized through known behavior of carbon dioxide with acidic polymers such as Nafion®, which is well known for stability towards carbon dioxide in fuel cells in which an operating life in excess of 5 years is routinely observed with no evidence of carbonate formation, even when the material is continuously exposed to carbon dioxide.

In alternative implementations, the acidic gas impermeable ionomer phase 36 could be replaced with a neutral ionomer, such as polyvinyl alcohol, as mentioned above. This phase could coincidentally act as a binder or as a hygroscopic material that would assist in the retention of water without the risk of flooding the catalyst 28.

The alkaline polymer 38 may be continuous through to the interface of the metal anode 34 such that the anode interface would be in galvanic contact with the catalyst 28. Likewise, the acidic gas-impermeable ionomer phase 36 may be contiguous through the catalyst layer 28 such that the catalyst interface would be in galvanic contact with the metal anode 34.

The catalyst 28 should have access to oxygen, the ionomer 36 (conductive phase to remove hydroxide), water, and the associated current collector. In order for these 5 components to come together in a triple phase boundary (consisting of gaseous air, liquid water with solvated ions, and a solid conductive catalyst), the catalyst interface may have a certain degree of porosity to allow gas access, yet include a path for electrons to transport in or out of the battery 24 along with a path for water and ions to transport within the battery 24. In order to prevent gases from permeating to the alkaline layer 38, however, a portion of the acidic polymer 36 may be configured as a membrane that allows transport of ions, but does not allow oxygen or carbon dioxide therethrough.

The acidic polymer functional group may include, for example, at least one sulfonic group (previously described), nitroso group, or phosphino group. The polymer backbone may be polystyrene, polysulfone, polyethersulfone, polyetheretherketone, polyphenylene, polybenzimidazole, polyimide, polyarylenether, or a fluorine-containing resin.

The alkaline polymer functional group may include, for example, at least one anion exchange group selected from quartenary ammonium, pyridinium, imidizolium, phosphonium, and sulfonium. The polymer may be polystyrene, polysulfone, polyethersulfone, polyetheretherketone, polyphenylene, polybenzimidazole, polyimide, polyarylenether, or a fluorine-containing resin.

These polymeric materials may be substantially solid such that intermixing between the materials is minimal and that the hydroxide gradient is maintained throughout the operational life of the battery 24.

The hydroxide distribution in such arrangements would result in higher concentrations at the anode and lower concentrations at the cathode, thus simultaneously protecting the cathode from passivation resulting from carbonate formation while facilitating alkaline anodic corrosion of the metal anode and preventing the direct oxidation of the metal.

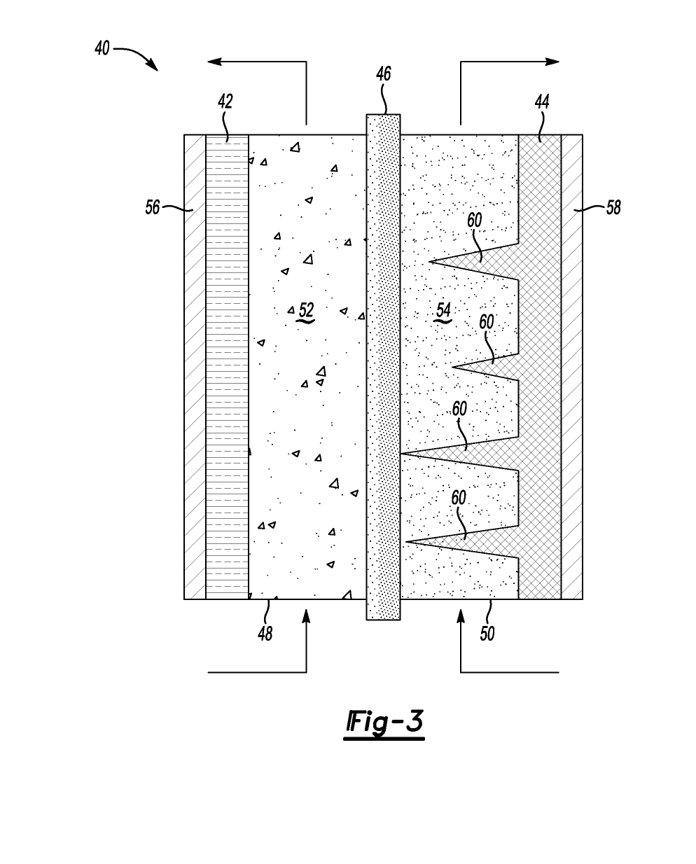

With reference to FIG. 3, an alkaline flow battery 40 may include a cathode 42, an anode 44, and a bipolar solid electrolyte 46 disposed therebetween. The cathode 42 and solid electrolyte 46 define a cathode chamber 48. The anode 44 and solid electrolyte 46 define an anode chamber 50. A catholyte 52 and anolyte 54 flow through the chambers 48, 50 respectively as indicated by arrow. Current collectors 56, 58 may be in contact with cathode 42 and anode 44 respectively. Other alkaline battery configurations are also contemplated.

As with the membrane electrode assemblies described above, dendrites 60 may grow from the anode 44 toward the cathode 42 during electrochemical charge. The solid electrolyte 46, however, is configured similar to the solid electrolyte 32 of FIG. 2. That is it may include a neutral (or acidic) gas impermeable ionomer phase adjacent to the cathode chamber 48 and an alkaline continuous ionomer phase adjacent to the anode 44. The hydroxide ion concentration associated with the neutral (or acidic) phase is thus sufficiently lower than that of the alkaline phase so as to prevent dendritic growth therethrough.

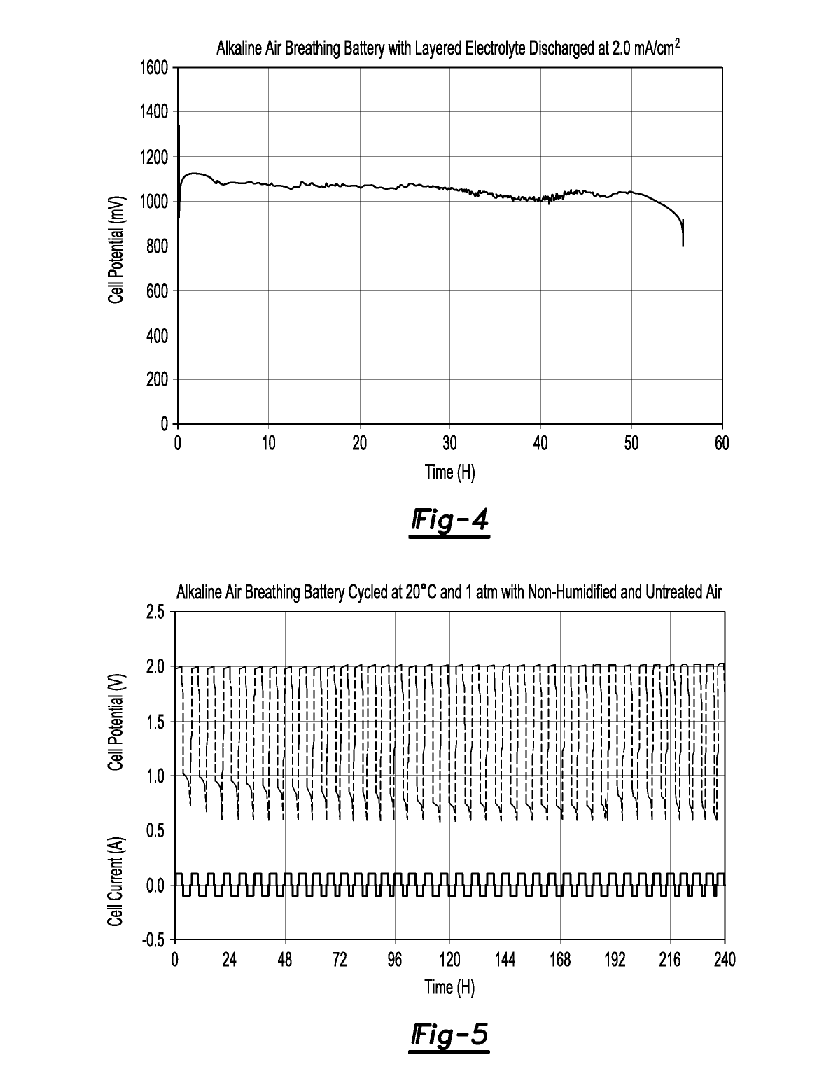

With reference to FIG. 4, experimental discharge results for an alkaline air breathing battery including a layered electrolyte similar to those described herein evidence high stability and functionality. It has been further previously demonstrated that a hydroxide ion concentration of about 4 molar or more arranged with an appropriate metal anode and a reversible air cathode may result in a cycle life of about 400 6 hour cycles. It has also been shown in cycling experiments detailed in FIG. 5 that more than 40 deep discharge cycles can be achieved using un-scrubbed and non-humidified air with a layered solid electrolyte similar to those described herein. As such, optimization of the materials and dimensions of the membrane electrode assemblies contemplated, in order to balance water transport, conductivity and reactivity, would extend the 80% depth of discharge cycle life to at least 400 cycles.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

1. An alkaline air breathing battery comprising:
a gas diffusion layer;
an air electrode in contact with the gas diffusion layer;
a counter electrode; and
a hydroxide containing solid anionic electrolyte in contact with and having an intrinsic cationic site gradient across and between the air and counter electrodes such that a hydroxide ion concentration at the air electrode is less than a hydroxide ion concentration at the counter electrode to reduce carbonate formation within the air electrode and to maintain hydroxide reaction at the counter electrode.

2. The battery of claim 1, wherein the electrolyte includes a hydroxide-phobic or hydroxide-neutral ionomer phase in contact with the air electrode.

3. The battery of claim 2, wherein the ionomer phase is gas impermeable.

4. The battery of claim 2, wherein the ionomer phase has a hydroxide ion concentration deficit sufficient to prevent penetrating dendritic growth in the ionomer phase that would lead to shorting between the air and counter electrodes.

5. The battery of claim 4, wherein the ionomer phase is a liquid, gel or polymer.

6. The battery of claim 1, wherein the hydroxide ion concentration at the air electrode is less than 10⁻⁵ molar.

7. The battery of claim 1, wherein the electrolyte includes a hydroxide-philic continuous ionomer phase in contact with the counter electrode.

8. An alkaline air breathing battery comprising:
a membrane electrode assembly including a catalyst layer, an anodic layer and a bipolar solid electrolyte disposed and having an intrinsic cationic site gradient across and between the layers and configured to inhibit reaction of carbon dioxide and hydroxide at a triple phase boundary of the catalyst layer and to promote oxidation of the anodic layer; and
a current collector in contact with the membrane electrode assembly.

9. The battery of claim 8 wherein the membrane electrode assembly further includes a gas diffusion layer in contact with the catalyst layer.

10. The battery of claim 8 wherein the membrane electrode assembly further includes a gas diffusion layer and a hydrophobic layer disposed between the catalyst layer and the gas diffusion layer.

11. The battery of claim 8 wherein the membrane electrode assembly further includes a separator arranged to prevent electrical shorting between the layers.

12. An alkaline air breathing battery comprising:
a membrane electrode assembly including a gas diffusion layer, a catalytic layer in fluid communication with the gas diffusion layer, an anodic layer and a bipolar solid electrolyte disposed and having an intrinsic cationic site gradient across and between the catalytic and anodic layers; and
a current collector in contact with the membrane electrode assembly, wherein the membrane electrode assembly and current collector are configured such that the battery, when cycled, achieves at least 40 charge-discharge cycles at a depth of discharge of at least 80%.

13. The battery of claim 12 wherein the membrane electrode assembly and current collector are configured such that the battery, when cycled, achieves at least 200 charge-discharge cycles at a depth of discharge of at least 80%.

14. The battery of claim 12 wherein the membrane electrode assembly and current collector are configured such that the battery, when cycled, achieves at least 400 charge-discharge cycles at a depth of discharge of at least 80%.

15. An alkaline air breathing battery comprising:
a membrane electrode assembly including a gas diffusion layer, a catalytic layer in fluid communication with the gas diffusion layer, an anodic layer and a bipolar solid electrolyte disposed and having an intrinsic cationic site gradient across and between the catalytic and anodic layers and configured to inhibit, during charge, dendritic growth between the anodic and catalytic layers; and
a current collector in contact with the membrane electrode assembly.

16. The battery of claim 15 wherein anodic layer is metal.

17. An alkaline battery comprising:
a cathodic layer, an anodic layer and a bipolar solid electrolyte disposed and having an intrinsic cationic site gradient across and between the cathodic and anodic layers and configured to inhibit, during charge, dendritic growth between the anodic and cathodic layers; and
a current collector in contact with at least one of the layers.
